(19) United States
(12) Patent Application Publication
(10) Pub. No.: US 2007/0075046 A1
(43) Pub. Date: Apr. 5, 2007

(54) Method for inhibiting damage due to arc between electrical contacts

(75) Inventors: Hisaya Nakamura, Chuo-ku (JP); Masakazu Harada, Chuo-ku (JP); Shiro Sakai, Chuo-ku (JP); Takaya Kondo, Makinohara-shi (JP); Tomohiro Shimada, Makinohara-shi (JP)

Correspondence Address: SUGHRUE-265550, 2100 PENNSYLVANIA AVE. NW, WASHINGTON, DC, 20037-3213, US

(73) Assignee: YAZAKI CORPORATION

(21) Appl. No.: 11/521,504

(22) Filed: Sep. 15, 2006

(30) Foreign Application Priority Data
Sep. 16, 2005 (JP) 2005-269715

(51) Int. Cl. H01H 33/66

(52) U.S. Cl. 218/123

(57) ABSTRACT

This method for inhibiting damage due to arc between electrical contacts involves the spreading of a grease composed of from 70% by weight to 95% by weight of a base oil and from 5% by weight to 30% by weight of a thickening agent and additives over a pair of electrical contacts in a circuit which causes terminals to move relative to each other so that they are disconnected from each other, whereby damage on the contact area due to arc occurring when the electrical contacts are isolated from each other is inhibited. As the thickening agent there is preferably used an organic bentonite. As the base oil there is preferably sued an ester oil, glycol oil or poly-α-olefin. The base oil preferably has a low density to reduce arc energy.

### BACKGROUND OF THE INVENTION

1. Field of the Invention

The present invention relates to a method for inhibiting damage due to arc between electrical contacts which inhibits the occurrence of arc between electrical contacts in circuit terminals in the circuit of an electrical apparatus such as sliding switch, connector and wire harness.

2. Related Art

Apparatus such as automobile have heretofore comprised many connectors, wire harnesses or other parts incorporated therein. A problem has arisen that arc occurring between the electrical contacts causes the corrosion of terminals and apparatus and thus reduces the life of the electrical parts. The grease to be incorporated in the sliding switch or the like in automobiles, for example, is required to have no adverse effects on apparatus made of a resin material such as ABS resin, undergo no change of properties due to heat generated by arc or heat by soldering of lead wires and undergo no adverse effects of low temperatures.

It is known that a grease for sliding contact has heretofore been used for sliding switches, etc. The grease for sliding contact comprises a particulate microporous clay mineral, a thickening agent composed of from 20:1 to 5:1 mixture by weight of lithium 12-hydroxystearate and lithium stearate and a phenol-based primary oxidation inhibitor incorporated therein in an amount of from 0.1 to 10 parts by weight, from 5 to 25 parts by weight and from 0.1 to 2 parts by weight, respectively, based on 100 parts by weight of a synthetic base oil mainly composed of a mixture of a low density σ-olefin-based synthetic oils having a density of from 8 cSt to 470 cSt (400°C.). The synthetic base oil contains a fluorine-based base oil in an amount of from 0.1% to 2% by weight. The particulate clay mineral is one or a mixture of two or more selected from the group consisting of organic bentonite, sepiolite, montmorillonite and synthetic mica (see, e.g., JP-A-4-114098).

As the grease for sliding contact there has been known one which exhibits various properties required for grease for sliding contact that generates electric arc when the contacts are opened and closed and a sufficient durability against ON/OFF of switch and can be colored without impairing its properties. The grease for sliding contact comprises one or more inorganic particulate materials selected from the group consisting of particulate zinc oxide and ferric trioxide (Fe₂O₃) having an average particle diameter of 0.6 μm or less and clay mineral which produces magnesium oxide when pyrolytically decomposed, lithium 12-hydroxystearate and phenol-based and/or amine-based primary oxidation inhibitor incorporated therein in an amount of from 0.2 to 3.0 parts by weight, from 3 to 20 parts by weight and from 0.1 to 5.0 parts by weight, respectively, based on 100 parts by weight of a grease composed of a synthetic hydrocarbon oil as a base oil (see, e.g., JP-A-5-179274).

Also is known a connector capable of eliminating or preventing arc generated when inserted or pulled out. The connector comprises a male connector and a female connector which can be fitted to each other in such an arrangement that the male connector can be freely inserted into or pulled out of the female connector. The housing of the female connector has a through-hole for contact of the male terminal of the male connector on the male terminal insertion/withdrawal surface. An arc inhibitor unit capable of spreading an arc inhibitor over the surface of the male terminal is provided. The arc inhibitor unit can be freely detached from the male terminal insertion/withdrawal surface and is formed by, e.g., a sponge impregnated with an arc inhibitor (see, e.g., JP-A-2003-45555).

Further known is an electrically-conductive grease for sliding switch which enhances the reliability and durability of a normally closed sliding switch which allows conduction while sliding and an On/OFF sliding switch which generates arc when it is opened and closed. The electrically-conductive grease for sliding switch comprises an organic material-affinitive quaternary ammonium salt-containing clay mineral and a lithium salt of higher aliphatic acid incorporated therein in an amount of from 10 to 20 parts by weight and from 5 to 20 parts by weight, respectively, based on 100 parts by weight of a base oil containing an alkylene oxide-polyvalent alcohol addition-polymerized oligomer and a chain-like hydrocarbon oligomer at a molar ratio of from 1:0.5 to 1.5 (see, e.g., JP-A-1-152197).

Still further known is a sliding switch coated with a lubricant or lubricating grease on the sliding surface thereof. The sliding switch is arranged such that a movable contact slides along the sliding surface of a stator made of an insulator and a fixed contact to cause itself to be connected to or separated from the fixed contact. The sliding surface of the stator and the movable contact are coated with different kinds of lubricant or lubricating grease which are immiscible with each other, respectively. As the lubricant to be spread over the movable contact there is used a grease comprising as a base oil a special water-repellent and oil-repellent fluorine-based oil which can be difficultly carbonized at high temperatures. As the lubricant to be spread over the stator side of the fixed contact there is used a grease comprising as a base oil a synthetic hydrocarbon oil or mineral oil (see, e.g., JP-A-63-48712).

Still further known is a lubricating grease adapted to be spread over the sliding surface of the contacts of a sliding switch which is arranged such that a movable contact slides along the sliding surface of a stator made of a resinous insulator and a fixed contact to open and close the switch directly unloaded. The lubricating grease is obtained by blending a metal soap grease comprising as a base oil a hydrocarbon-based oil with an active oil-absorbing polymer/oligomer containing an unsaturated component having a flash point of 250° C. or more or with a high melting wax together with the oil-absorbing polymer/oligomer. The lubricating grease is applied to the sliding surface of the contacts of a sliding switch which generates electric arc of few amperes to scores of amperes at the switch opening/closing position when the switch is opened and closed in order to directly unload the switch (see, e.g., JP-A-63-137995).

With the tendency for the enhancement of voltage required for automobile power supply, etc., it has been apprehended that the generation of arc between the terminals of connector, wire harness, etc. causes the occurrence of malcontact or damage on connector terminals, disabling the re-mounting of connector or causing malcontact of contacts. Arc occurs between the electrical contacts in an electrical apparatus such as connector and wire harness when the switch contacts are disconnected, particularly isolated from each other. The generation of arc between the electrical contacts causes the occurrence of galvanic corrosion or fusion in the contacts as well as in its vicinity, resulting in the deterioration of durability of the electrical contacts.

### SUMMARY OF THE INVENTION

An aim of the invention is to provide a method for inhibiting damage due to arc between electrical contacts which comprises spreading a special grease over the contacts to inhibit the generation of arc between the electrical contacts when they are disconnected from each other, whereby damage, particularly fusion and corrosion, on the contacts and its vicinity due to air discharge, i.e., arc occurring between the electrical contacts can be inhibited to enhance the durability of electrical contact regions such as connector and realize the prolongation of the life thereof, thereby solving the aforementioned problems.

The invention concerns a method for inhibiting damage due to arc between a pair of electrical contacts in a circuit which causes terminals to move relative to each other so that they are disconnected from each other, wherein a grease composed of from 70% by weight to 95% by weight of a base oil and from 5% by weight to 30% by weight of a thickening agent and additives is spread over at least the electrical contact of the terminals so that when the electrical contacts are connected to each other and separated and disconnected from each other, the presence of the grease between the electrical contacts inhibits damage due to arc.

In the aforementioned method for inhibiting damage due to arc between electrical contacts, the amount of the thickening agent and the additives are 15% by weight or less and 10% by weight or less, respectively, based on the amount of the base oil.

Further, the viscosity of the base oil is predetermined to be lowest if the base oil is selected from the group consisting of the same kind of base oils. In this arrangement, the arc energy can be lowered.

Moreover, the aforementioned grease is selected from the group consisting of insulating greases, electrically-conductive greases and semiconductor region greases. In particular, the aforementioned grease is preferably predetermined to have a volume resistivity of from 10⁵ to 10⁹ Ω·cm from the standpoint of conduction or protection properties by the grease.

Further, the aforementioned base oil is composed of one or more selected from the group consisting of paraffin-based mineral oils, naphthene-based mineral oils, poly-α-olefin-based oils, diester-based oils, polyolester-based oils, diphenylether-based oils and polyalkylene glycol-based oils.

Moreover, the aforementioned thickening agent is composed of one or more selected from the group consisting of lithium soaps, calcium soaps, urea soaps, aluminum soaps, calcium composite soaps and organic bentonite. The aforementioned thickening agent may be in a particulate form such as grain, fiber, scale, needle and amorphous form. Most desirable among these particulate forms is grain from the standpoint of follow-up properties and protection of metal surface.

Further, the aforementioned additives are composed of one or more selected from the group consisting of oxidation inhibitors, electrically-conductive solid powders, antistatic agents and thickening agents. Moreover, the aforementioned electrically-conductive solid powder is composed of one or more selected from the group consisting of powder of metal such as aluminum and titanium oxide and carbon black. Further, the aforementioned antistatic agent is composed of one or more selected from the group consisting of nonionic surface active agents, anionic surface active agents, cationic surface active agents and mixture of anionic and cationic surface active agents.

The method for inhibiting damage due to arc between electrical contacts is preferably applied to electrical apparatus such as wire harness, connector and switch.

In accordance with the method for inhibiting damage due to arc between electrical contacts of the invention, the terminal electrical contacts in a wire harness, connector, switch or the like is coated with a grease as mentioned above. In this arrangement, during the connection and disconnection of the electrical contacts, the metallic surface of the electrical contacts is protected by the grease to inhibit damage due to air discharge, i.e., arc and reduce the arc energy, i.e., arc duration time. Thus, fusing, corrosion and other troubles of the electrical contacts can be inhibited, making it possible to enhance the durability of electrical apparatus.

### BRIEF DESCRIPTION OF THE DRAWINGS

FIG. 1 is a circuit diagram illustrating an electric circuit for measuring the energy of arc on a grease in the method for inhibiting damage due to arc between electrical contacts according to the invention.

FIG. 2 is a schematic diagram illustrating an example of the electrical contacts in the electric circuit of FIG. 1.

FIG. 3 is a diagram illustrating the volume resistivity of various greases.

FIGS. 4A and 4B are schematic diagrams illustrating a testing equipment for measuring the volume resistivity of the various greases of FIG. 3.

FIG. 5 is a graph illustrating the energy of arc on base oils in a simple body used in the method for inhibiting damage due to arc between electrical contacts according to the invention.

### DETAILED DESCRIPTION OF THE PREFERRED EMBODIMENTS

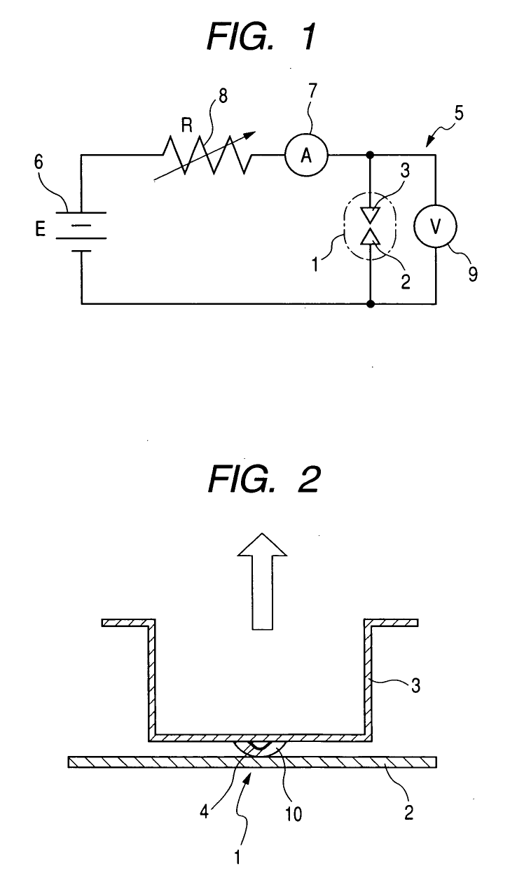

The method for inhibiting damage due to arc between electrical contacts according to the invention can be applied to a circuit which causes a pair of terminals to move relative to each other so that the electrical contacts thereof are disconnected. The method for inhibiting damage due to arc between electrical contacts according to the invention will be verified in connection with FIGS. 1 to 5.

The method for inhibiting damage due to arc between electrical contacts according to the invention is particularly characterized in that a grease composed of from 70% to 95% by weight of a base oil excluding fluorine-based oil and from 5% to 30% by weight of a thickening agent and additives is spread over the terminal electrical contacts and an area in the vicinity thereof before the connection of the electrical contacts to each other so that when the electrical contacts are connected to each other and disconnected from each other, the presence of the grease between the electrical contacts prevents the formation of a direct gap between the metal of the electrical contacts, making it possible to inhibit damage due to arc in the electrical contacts and in its vicinity. As the grease there may be used an insulating grease or electrically-conductive grease. The base oil is composed of one or more selected from the group consisting of paraffin-based mineral oils, naphthene-based mineral oils, poly-α-olefin(PAO)-based oils, diester-based oils, polyolester-based oils, diphenylether-based oils and polyalkylene glycol-based oils.

The base oil constituting the grease is essentially non-conductive and thus allows no electric current to flow therethrough. However, even when the electrical contacts are coated with abase oil or grease, electric current flows through the electrical contacts when the metal of the electrical contacts come in contact with each other or flows through the electrical contacts at an area having a thin oil film. Further, in this phenomenon, the electrical contact region can generate heat due to constriction resistance. In some detail, when the electrical contacts are separated from each other, the resulting constriction resistance causes heat generation that fuses the metal of the electrodes to form a bridge. When the electrodes are further separated from each other, the bridge breaks to cause electricity to pass through the air layer, resulting in the occurrence of air discharge, i.e., arc. When the electrical contacts are coated with a base oil or grease, the metallic surface of the electrical contacts is protected by the coat of the base oil or grease, making it possible to eliminate the effect of arc.

Referring to the method for inhibiting damage due to arc between electrical contacts, the arc duration time was detected using an electric circuit 5 shown in FIG. 1 to evaluate the damage on the test specimen, i.e. electrical contacts 1. The electric circuit 5 is normally adapted to measure the voltage V applied from a power supply 6 to the electrical contacts 1 by a voltmeter 9. The electric circuit 5 has an ammeter 7 and a variable resistor 8 incorporated therein for measuring electric current I and resistivity, respectively. The test specimen prepared comprises electrical contacts 1 composed of a movable terminal 3 made of copper and a fixed terminal 2 made of copper, respectively. A protruding contact 4 was formed on the movable terminal 3. Various greases 10 were each spread sequentially over the contact 4 and its vicinity. The fixed terminal 2 was moved from the fixed terminal 2 against the connection of the movable terminal 3 to the fixed terminal 2, i.e., ON state at a velocity of 500 mm/min to make the contact 4 OFF. At this point, the duration time of arc occurring on the electrical contacts 1 was measured on each of the various greases 10 to determine the arc energy.

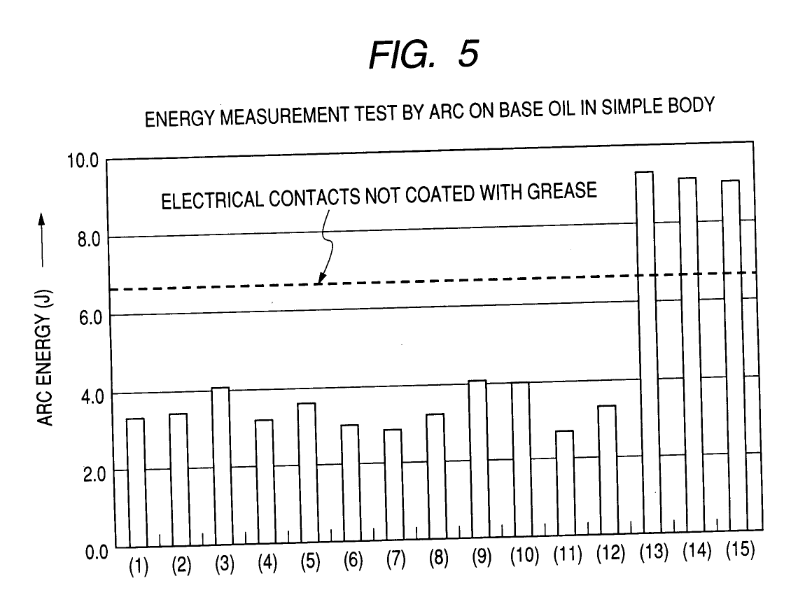

Referring to the base oil, the arc energy was about 6.5 J when the electrical contacts were not coated with a grease (shown by dotted line) as shown in FIG. 5. When the electrical contacts were coated with a grease as in the invention, the arc energy was within a range of from 2.7 J to 4.1 J. Referring to the base oil in particular, when polyalkylene glycol oils or polyolester oils were used, the arc energy was low. The arc energy (J) developed with various oils are set forth in Table 1. The dynamic viscosity (mm²/s) of the base oils were determined at 40° C. The results set forth in Table 1 are graphically shown in FIG. 5. In FIG. 5, the reference numerals (1) and (2) each indicate a paraffin-based mineral oil, the reference numeral (3) indicates a naphthene-based mineral oil, the reference numerals (4) and (5) each indicate a poly-α-olefin oil, the reference numeral (6) indicates a diester oil, the reference numerals (7) and (8) each indicate a polyolester oil, the reference numerals (9) and (10) each indicate a diphenylether oil, the reference numerals (11) and (12) each indicate a polyalkylene glycol oil, the reference numerals (13) and (14) each indicate a straight-chain type fluorine-based oil, and the reference numeral (15) indicates a branched type fluorine-based oil.

TABLE 1
Relationship of arc energy to dynamic viscosity of base oil

| | Reference | Dynamic viscosity | |
|---|---|---|---|
| | numeral | at 40° C. | |
| Base oil | in FIG. 5 | (mm²/s) | Arc energy |
| Paraffin-based oil 1 | (1) | 68 | 3.39 |
| Paraffin-based oil 2 | (2) | 66 | 3.52 |
| Naphthene-based oil | (3) | 235 | 4.10 |
| Poly-α-olefin oil 1 | (4) | 30 | 3.27 |
| Poly-α-olefin oil 2 | (5) | 400 | 3.66 |
| Diester oil | (6) | 10.6 | 3.11 |
| Polyolester oil 1 | (7) | 20 | 2.97 |
| Polyolester oil 2 | (8) | 71.7 | 3.29 |
| Diphenylether oil 1 | (9) | 44 | 4.06 |
| Diphenylether oil 2 | (10) | 97 | 3.97 |
| Polyalkylene glycol oil 1 | (11) | 64.5 | 2.79 |
| Polyalkylene glycol oil 2 | (12) | 351 | 3.33 |
| Fluorine-based oil | (13) | 17 | 9.33 |
| (straight-chain type) 1 | | | |
| Fluorine-based oil | (14) | 85 | 9.11 |
| (straight-chain type) 2 | | | |
| Fluorine-based oil | (15) | 345 | 9.01 |
| (branched chain type) 3 | | | |

As can be seen in Table 1 and FIG. 5, mineral oils such as paraffin-based mineral oil and naphthene-based mineral oil produce a smaller arc energy as its viscosity is lower. It was also made obvious that the poly-α-olefin oil, polyolester oil and polyalkylene glycol oil, too, produce a smaller arc energy as its viscosity is lower. However, the diphenyl ether oil gave results opposite to those described above. By way of comparative example, when the electrical contacts 1 were coated with a fluorine-based oil as a base oil, the arc energy ranged from 9.0 J to 9.4 J as shown in Table 1 and FIG. 5. After the examination, the electrical contacts were observed to have corrosion. Thus, fluorine-based oils were confirmed undesirable from the standpoint of inhibition of damage due to arc. It was further made obvious that when the electrical contacts 1 are coated with a fluorine-based oil/fluorine-based grease, the resulting constriction resistance or heat generation by arc causes the fluorine-based oil/fluorine-based grease to be thermally decomposed to hydrofluoric acid that prolongs the arc duration time, causing the occurrence of corrosion and other defects on the electrical contacts and its vicinity.

Further, the grease or the base oil constituting the grease is essentially an insulating material but can be an electrically-conductive grease or semi-conductive grease when it has an electrically-conductive solid powder such as carbon black, graphite and metallic powder dispersed therein. In the method for inhibiting damage due to arc between electrical contacts of the invention, the arc energy developed when the electrical contacts are coated with an electrically-conductive grease excluding the fluorine-based grease described later, i.e., arc duration time with the electrically-conductive grease is smaller than that with insulating greases. This phenomenon is presumably attributed to the flowing of electric current through the grease. However, when the grease is attached to the area in the vicinity of the terminals, it is likely that short-circuiting can occur. Therefore, when the electrical contacts are coated with the grease, special care has to be exercised to prevent the grease from being attached to other areas and from dragging to other areas. In the case where the electrical contacts are coated with an insulating grease, damage on the electrical contacts due to arc can be inhibited presumably because the grease still covers the surface of the electrical contacts even when the electrical contacts are separated from each other.

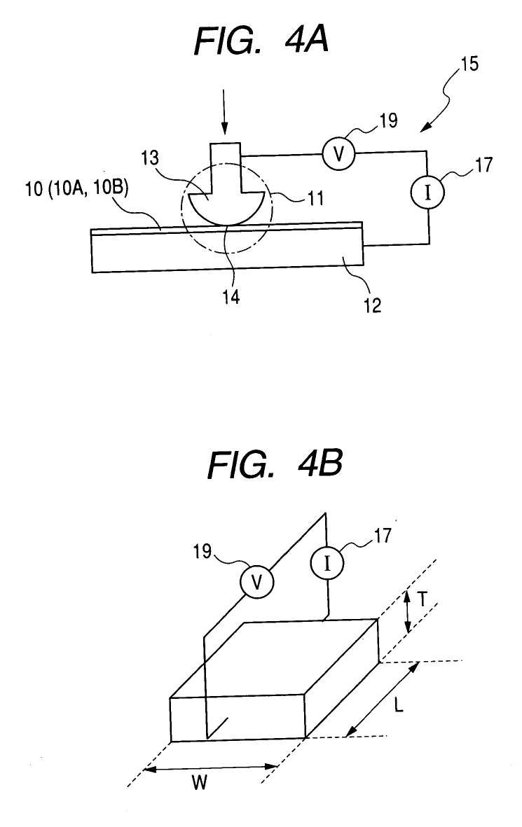

The electric conductivity of greases as measured by the experimental device shown in FIG. 4A was confirmed. The volume resistivity of greases was measured using the experimental device shown in FIG. 4B. As shown in FIG. 4A, a fixed terminal 12 and a movable terminal 13 in the electrical contacts 11 were each coated with each of various greases 10. In an electric circuit 15 having one end connected to the fixed terminal 12 and the other connected to a movable terminal 13 were incorporated a voltmeter 19 and an ammeter 17. The various greases 10 were each then measured for volume resistivity M under a predetermined load applied to the movable terminal 13. Since the voltage V the current I and the resistivity R bear the relationship V=I·R, the volume resistivity of the grease 10 is represented by the following equation supposing that the width, height and length of the coat layer of the grease 10 are W, T and L, respectively, as shown in FIG. 4B:
M=R·(W/L)·T

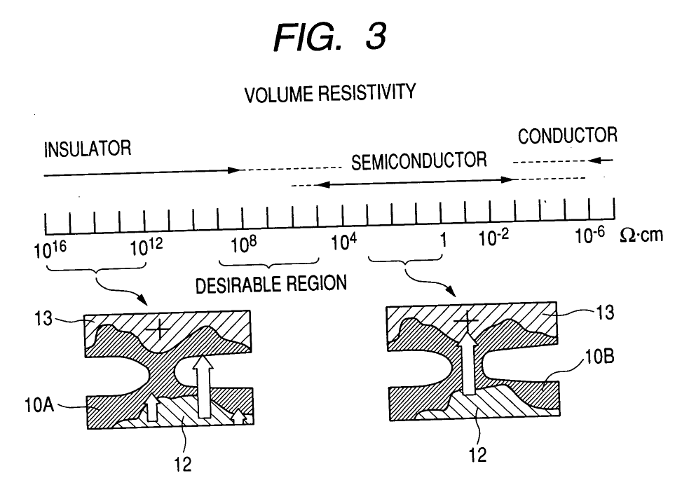

The purpose of measuring the volume resistivity M is to confirm the phenomenon that when the contact 14 of the fixed terminal 12 and the movable terminal 13 are each coated with the grease 10, conduction is made if the distance between these contacts 14 is extremely short while no conduction is made if the contacts 14 are sufficiently separated from each other and thus determine the spreading conditions of the grease 10. The measurement was made even when the length L of the grease coat was extremely short. FIG. 3 indicates ordinary volume resistivity values M. Insulating materials exhibit a volume resistivity of from 10⁸ to 10¹⁶ Ω·cm, semiconductors exhibit a volume resistivity of from 10⁻³ to 10⁵ Ω·cm and conductors exhibit a volume resistivity of 10⁻⁵ Ω·cm or less. In the measurement of the invention, the insulating grease 10A exhibited a volume resistivity of from 10¹² to 10¹⁶ Ω·cm and the electrically-conductive grease 10B exhibited a volume resistivity of from 10³ to 1 Ω·cm. The insulating grease 10A is insulating itself. Accordingly, even when the contacts 14 were separated from each other, the surface of the contacts 14 were still covered by the grease 10A and thus could be prevented from being damaged due to arc. The electrically-conductive grease 10B is electrically-conductive itself. Accordingly, even when the contacts 14 were separated from each other, electric current flows across the electrodes, i.e., contacts 14 through the grease 10B, making it difficult for arc to occur. Referring to the ideal range within which when the distance between the electrical contacts is short, the grease 10 allows slight conduction while when the electrical contacts are sufficiently separated from each other, the grease 10 spread over the electrical contacts protects the electrical contacts taking into account these phenomena, it is thought that when the grease 10 is in a semiconductor region, damage on the electrical contacts due to arc can be inhibited.

The viscosity of the base oil to be used in the method for inhibiting damage due to arc between the electrical contacts will be considered below. Referring to the viscosity of the base oil, it is thought that a grease having a viscosity as low as 10 mm²/s or less at 100° C. can be easily applied to the electrical contacts and can reduce arc energy to advantage. In some detail, it was made obvious that when as base oils there are used insulating base oils/greases having a low viscosity, arc energy can be reduced. This is presumably because these base oils can protect the metallic surface of the electrical contacts and exhibit excellent wetting properties with respect to metal and hence no stringiness, i.e., no follow-up properties. On the other hand, insulating base oils having a high viscosity gave a raised arc energy. This is presumably because when the electrical contacts are separated from each other at a high velocity, these base oils cannot form an oil film between the electrical contacts and thus exhibit deteriorated wetting properties with respect to metal and hence some stringiness, i.e., some follow-up properties. Essentially, oils/greases are a nonconductor and thus allow no conduction. As the distance between the electrical contacts increases, the resulting constriction resistance causes the electrical contacts to generate heat that fuses the metal to form a bridge. At this point, conduction occurs at the bridge or at an area having a thin oil film. Subsequently, when the bridge breaks, air discharge, i.e., arc occurs. In accordance with the invention, it is thought that the grease protects the electrical contacts and its vicinity, making it possible to assure desired durability.

As can be seen in the foregoing description, the arc resistance of a base oil itself is governed by the viscosity thereof more than by the kind of the base oil, demonstrating a tendency that a low density oil is better than a high density oil. It is also made obvious that as an oil having a high arc resistance there is most preferably used a low density ester-based oil or low density glycol oil.

The thickening agent to be used in the method for inhibiting damage due to arc between electrical contacts will be further described hereinafter. The thickening agent to be incorporated in the grease may be composed of one or more selected from the group consisting of lithium soaps, calcium soaps, urea soaps, aluminum soaps, calcium composite soaps and organic bentonite. In order to examine the thickening agent for conductivity, the grease was measured for contact resistance under a load between the electrical contacts. An organic bentonite occasionally cannot conduct even when the electrical contacts are coated with a grease containing the organic bentonite depending on the shape of the particulate bentonite. In this case, the electrical contacts were coated with a grease containing an ordinary amount of the organic bentonite. The grease containing the organic bentonite was then wiped off with a wiper or the like to form a thin grease film which was then examined for conductivity. In order to examine the electrical contacts coated with a grease containing a thickening agent for conductivity, the electrical contacts were examined for contact resistance under a load of from 83 gf to 100 gf. When the contact resistance between the electrical contacts was 40 mΩ, it was judged that the thickening agent has a good conductivity.

The conductivity test of the electrical contacts coated with a grease containing a thickening agent showed that the conductivity of the grease is greatly affected by the content of the thickening agent in the grease, particularly bentonite grease. When the electrical contacts are coated with a grease containing a large amount of a thickening agent, arc energy tends to decrease, but conductivity is deteriorated. It was also made obvious that when the electrical contacts are coated with a grease containing a thickening agent, arc energy drastically decreases more than the electrical contacts free of grease. The less the content of the thickening agent is, the better is the conductivity of the grease. For example, a grease containing a thickening agent in an amount of from 5% to 11% by weight based on the base oil is good. When the content of the thickening agent is about 15% by weight, the conductivity of the grease begins to drop. When the content of the thickening agent exceeds 15% by weight, e.g., 20% by weight, the resulting grease exhibits a deteriorated contact resistance. An organic bentonite occasionally cannot conduct even when the electrical contacts are coated with a grease containing the organic bentonite depending on the shape of the particulate bentonite. In this case, the electrical contacts are coated with a grease containing an ordinary amount of the organic bentonite. The grease containing the organic bentonite is then wiped off with a wiper or the like to form a thin grease film that can exert an effect of inhibiting damage due to arc. However, it was made obvious that when the electrical contacts coated with an increased amount of a grease containing an organic bentonite having a particle shape allowing conduction even with an ordinary spread, a tendency for further reduction of arc energy is shown. The effect of the difference in spread was not so great as the effect of the change from absence of grease to presence of grease. The inhibition of damage due to arc can be best carried out by the use of an organic bentonite or calcium composite soap. In particular, the grease containing an organic bentonite exhibited almost the same arc energy, i.e., arc duration time as other greases but gave extremely small damage on the minus (−) electrode side contact.

As the additives there may be used one or more selected from the group consisting of oxidation inhibitors, electrically-conductive solid powders, antistatic agents and thickening agents. In other words, as the additives there may be selected those satisfying desired properties to assure the desired properties. Further, the electrically-conductive solid powder can be composed of one or more selected from the group consisting of powder of metal such as aluminum and titanium oxide and carbon black. The antistatic agent can be composed of one or more selected from the group consisting of nonionic surface active agents, anionic surface active agents, cationic surface active agents and mixture of anionic and cationic surface active agents. It suffices if these antistatic agents are incorporated in the grease or base oil in an amount of 10% by weight.

Summarizing from the foregoing description, the method for inhibiting damage due to arc between electrical contacts of the invention involves the spreading of an insulating or electrically-conductive grease over the electrical contacts to inhibit damage due to arc. A grease and a base oil each are a non-conductive material and essentially allow no conduction of electric current but allow conduction of electric current at an area having a thin oil film. When the bridge of grease formed by constriction resistance at the electrical contacts breaks, arc occurs. The protection of the surface of the electrical contacts by the grease or base oil makes it possible to inhibit damage due to arc. Most of the base oils, excluding fluorine-based oils, exhibit a good arc resistance. In some detail, referring to base oils, ester-based oils glycol-based oils are most desirable. Poly-α-olefins (PAO) come next. Other oils come last. It was also made obvious that when the base oil is selected from the same kind of insulating oils, an insulating oil having a low density can be used to advantage. In some detail, an oil having a high density gives a raised arc energy. This is because an oil having a high density has some stringiness, i.e., some follow-up properties and hence deteriorated wetting properties with respect to the metal constituting the electrical contacts and thus cannot form a sufficient oil film when the electrical contacts are separated from each other at a high velocity. On the other hand, an oil having a low density gives a reduced arc energy. This is because an oil having a low density has no stringiness, i.e., no follow-up properties and hence excellent wetting properties with respect to the metal constituting the electrical contacts and thus can form a sufficient oil film even when the electrical contacts are separated from each other at a high velocity. Referring to the effect of thickening agent of inhibiting damage due to arc, organic bentonites and calcium composite soaps give best results. Silica comes next. Urea compounds and other various metal soaps come last. In particular, it is thought that when the organic bentonite is used, heat-resistant particles are present on the surface of the electrical contacts to protect the electrical contacts. It was further made obvious that the organic bentonite exhibits a most advantageous arc resistance because it can adsorb materials produced by arc.

The method for inhibiting damage due to arc between electrical contacts according to the invention can be applied to arc between a pair of electrical contacts in a circuit which causes terminals to move relative to each other so that they are disconnected from each other. In particular, the method for inhibiting damage due to arc between electrical contacts according to the invention is applied to electrical apparatus such as wire harness, connector and switch incorporated in automobiles, etc. to advantage.

What is claimed is:

1. A method for inhibiting damage due to arc between a pair of electrical contacts in a circuit which causes terminals to move relative to each other so that the terminals are disconnected from each other, wherein a grease composed of from 70% by weight to 95% by weight of a base oil and from 5% by weight to 30% by weight of a thickening agent and additives is spread over at least the electrical contact of the terminals so that when the electrical contacts are connected to each other and separated and disconnected from each other, the presence of the grease between the electrical contacts inhibits damage due to arc.

2. The method for inhibiting damage due to arc between electrical contacts according to claim 1, wherein the amount of the thickening agent and the additives are 15% by weight or less and 10% by weight or less, respectively, based on the amount of the base oil.

3. The method for inhibiting damage due to arc between electrical contacts according to claim 1, wherein the viscosity of the base oil is predetermined to be lowest if the base oil is selected from the group consisting of the same kind of base oils.

4. The method for inhibiting damage due to arc between electrical contacts according to claim 1, wherein as the grease there is used an insulating grease, an electrically-conductive grease or a semiconductor region grease.

5. The method for inhibiting damage due to arc between electrical contacts according to claim 4, wherein the grease exhibits a volume resistivity of from 10⁵ to 10⁹ Ω·cm.

6. The method for inhibiting damage due to arc between electrical contacts according to claim 1, wherein the base oil is composed of one or more selected from the group consisting of paraffin-based mineral oils, naphthene-based mineral oils, poly-α-olefin-based oils, diester-based oils, polyolester-based oils, diphenylether-based oils and polyalkylene glycol-based oils.

7. The method for inhibiting damage due to arc between electrical contacts according to claim 1, wherein the thickening agent is composed of one or more selected from the group consisting of lithium soaps, calcium soaps, urea soaps, aluminum soaps, calcium composite soaps and organic bentonite.

8. The method for inhibiting damage due to arc between electrical contacts according to claim 7, wherein the thickening agent has a grain-like particle shape.

9. The method for inhibiting damage due to arc between electrical contacts according to claim 1, wherein the additives are composed of one or more selected from the group consisting of oxidation inhibitors, electrically-conductive solid powders, antistatic agents and thickening agents.

10. The method for inhibiting damage due to arc between electrical contacts according to claim 9, wherein the electrically-conductive solid powder is selected from the group consisting of powder of metal such as aluminum and titanium oxide and carbon black.

11. The method for inhibiting damage due to arc between electrical contacts according to claim 9, wherein the antistatic agent is composed of one or more selected from the group consisting of nonionic surface active agents, anionic surface active agents, cationic surface active agents and mixture of anionic and cationic surface active agents.

12. The method for inhibiting damage due to arc between electrical contacts according to claim 1, which is applied to electrical apparatus such as wire harness, connector and switch.
